(19) United States
(12) Patent Application Publication
(10) Pub. No.: US 2009/0296401 A1
(43) Pub. Date: Dec. 3, 2009

(54) Devices and Methods for Resonant Illumination

(75) Inventor: Enrique Gutierrez, JR., Littleton, CO (US)

Correspondence Address: MORRISON & FOERSTER LLP, 755 PAGE MILL RD, PALO ALTO, CA, 94304-1018, US

(73) Assignee: OMNILUX, INC., Highlands Ranch, CO (US)

(21) Appl. No.: 11/665,109

(22) PCT Filed: Mar. 20, 2007
(86) PCT No.: PCT/US2007/007293

§ 371 Date: Jun. 18, 2009

Related U.S. Application Data
(60) Provisional application No. 60/784,435, filed on Mar. 20, 2006.

(51) Int. Cl. F21V 17/02

(52) U.S. Cl. 362/284

(57) ABSTRACT

Described herein are methods, devices and systems for effective, adjustable wide-field illumination. In particular resonant engines for illuminating a broad area by resonant oscillation, and methods of moving at least one mirror at or near a resonance are described. A resonant engine includes one or more mirrors that may be oscillated to reflect light from a light source(s) to create a target illumination pattern. Devices and systems in which the mirror or mirrors are oscillated at an energy-efficient manner are described. Also described are optics, control features, and techniques that may be utilized to enhance the energy efficiency of the resonant engines and system described.

### CROSS-REFERENCES TO RELATED INVENTIONS

This patent claims priority to U.S. Provisional Patent application 60/784,435, filed Mar. 20, 2006, which is herein incorporated by reference in its entirety.

### TECHNICAL FIELD

This application generally relates to the field of illumination and light devices. In particular, the application relates to uniform and adjustable illumination of a wide area. The application applies both to visible and non-visible regions of the electromagnetic spectrum.

### BACKGROUND

Most lighting devices are static lighting devices. This means that these lighting devices operate by providing an illumination source (e.g., a lamp) that emits light in a fixed or stationary pattern. Power is provided to the lamp, and the light emitted may be at least partially reflected by a mirror to illuminate a target or target region. Static lighting devices may include handheld, mobile and fixed mount lighting. One example of a static lighting device is an interior residential lamp. An interior lamp generally includes at least a bulb and an input for electrical energy. When energized, the bulb may create a multidirectional static illumination pattern emanating from the bulb. The resulting illumination area typically radiates from the illumination source (e.g., bulb), and may be non-uniform. For example, the illumination may be dimmer further from the lighting source, and brighter near the illumination source. The light from a static lighting device may also be directed by including one or more reflective surfaces that can direct (or guide) the light from the light source (e.g., bulb). In this case, light may be directed to cover a smaller area, but the resulting light (from the combination of light source and mirror) may be brighter. Focused lamp devices typically increase brightness but decrease illumination coverage area. To illuminate a larger area with an equivalent intensity of light, it is generally necessary to provide more power to the light source. A diffuser (e.g., a lamp shade) may also be used to redirect the light from the illumination source.

However, it may be desirable to increase the area illuminated by a lighting device without increasing the power supplied to the illumination source, or the size and/or wattage of the illumination source. For some applications, increased intensity, energy savings, non-conical beam patterns, adjustable light patterns, beam patterns with sharp cut-off or uniformity may be desired. The use of larger power traditional light bulbs is therefore undesirable.

One proposed solution has been to move or scan a light over a larger area to illuminate the larger area. However, significant problems arise when scanning a light source over a large area (which may also be referred to as a moving lamp design). For example, moving a lamp at a non-resonant frequency typically requires increased power and/or increased cost. Additionally moving the lamp device may decreases the reliability and operating life of the bulb due to mechanical shock and stress.

For example, U.S. Pat. No. 5,816,689 to Stazzabosco, describes an apparatus that oscillates a beam of light, to create a wide area of illumination. Strassabosco teaches mostly an electrical means to achieve movement of a light source comprising a combination bulb and mirror. Unfortunately, few common bulbs hold up well under the forces created by this mechanical movement. Additionally the power required to move a system at resonance increases exponentially as the weight increases. Common bulbs are typically composed of glass and metal both of which are relatively heavy, requiring an increase in energy required to provide movement. Even lighter semiconductor devices (which might better withstand this type of movement) typically require heavy heat sinks for heat dissipation.

One undesirable side-effect of oscillating the beam of light is the stroboscopic effect (including temporal aliasing). Stroboscopic effects may result when the rate of oscillation of the light beam is near or less than the rate that objects being illuminated by the light beam are moving. To an observer, the moving object would appear to jump or to move discontinuously. A similar effect may be seen when the frequency of oscillation is near or less than the sampling rate that an illuminated area is being viewed (e.g., particularly when the illuminated area is being recorded). Stroboscopic effects may be avoided or eliminated by increasing the rate of oscillation of the light beam. However, increasing the rate of movement typically requires increasing the energy needed to move the light source, and may further degrade the illumination system components, as increased stresses may be applied to the system.

Thus, there is a need for a more practical and energy-efficient means of creating a large optimal illumination area. In particular, there is a need for energy-efficient means of creating a large illumination area in which stroboscopic flicker is reduced, while still maintaining low power consumption and assuring bulb and related component reliability.

Described herein are devices methods and systems that may address the problems described above. In particular, these devices and system may create an energy-efficient, adjustable and uniform wide-ranging area of illumination while optimizing the power supplied to the system, including the light source. The system may illuminate a broad (or adjustable) area by efficiently oscillating one or more mirrors at or near a resonant frequency in a relatively undamped manner, resulting in a rapid oscillation that requires only minimal energy to sustain.

### SUMMARY OF THE INVENTION

The devices, systems, and methods described herein illustrate oscillating mirror systems that may be used with a light source to provide illumination that is highly effective, and may be energy efficient. In particular, described herein are illumination systems that oscillate one or more mirrors to light a broad region while operating at or near a resonant frequency or its harmonic. Also described herein are methods and devices for applying a minimum of power to move a mirror reflecting light from a light source so that it illuminates a broad area. Various features may be used to help insure that the resulting illumination is uniform, adequately intense, and has a specific distribution. Any or all of the features described herein may be combined to form an illumination system or a part of an illumination system, as described more fully below.

In some variations, the devices described herein include reflective systems that project light from a light source over a broad area. These devices may be used with a separate light source (including collimated light sources) or they may include a light source as part of the system. In general, the devices and systems described herein include one or more mirrors (which may be referred to as mirrors), a bias that is configured to oscillate the mirror over some range of motion (which may be adjustable), and a mirror driver that drives the oscillation of the mirror by loading and/or unloading the bias. The mirror and bias may form a mirror subassembly that is attached to a housing, support or base. The movement of the mirror and bias may therefore have one or more resonant frequencies. Thus, these devices for reflecting light to illuminate an area may be referred to as “resonant engines” because they may drive loading and unloading of the bias (e.g., spring) and mirror(s) around these resonant frequencies.

These devices described herein may be configured to reflect light to illuminate a wide area in an energy-efficient manner. These reflective devices may include an engine support (e.g., a housing) and a movable mirror that is operatively connected to a bias. The bias may be mounted to the engine support. The bias may also be configured to move the mirror with respect to the engine support in an undamped oscillation. For example, the bias and mirror may be connected to each other so that the mirror is able to move as the bias is loaded and unloaded, and the bias may be connected to a fixed (relative to the mirror) wall or base of the engine support while the mirror is only connected to the base through the bias. The device may also include a mirror driver that is configured to move the mirror at a resonant frequency (a resonant frequency of the mirror and bias subsystem) by loading and unloading the bias. When collimated light produced by a light source is projected onto the oscillating mirror, the mirror may form an illumination pattern.

Any appropriate bias may be used. A bias may be an elastic material or a structure having elastic properties (e.g., elasticity or resilience) that can be loaded and unloaded. For example, a bias may be selected from the group consisting of: a spring, an electrometric band, a string, a plastic member, a rubber member, a metal member, or a composite member, or some combination thereof. One particular example of a bias is a clock spring. In some variations more than one bias may be used.

Any appropriate engine support may be used. An engine support may be a housing, and may also enclose one or more portions of the device. In some variations, the engine support is a framework (e.g., a rigid framework) or scaffolding. The engine support may not fully enclose any portion of the device. In general, the engine support does not move with respect to the mirror or mirror subassembly. Thus, the engine support may be mountable in order to fix the device in place, or may include a stand or base for positioning the resonant engine.

A mirror driver typically loads the bias by applying force that displaces the bias (moving the mirror). The bias may then be unloaded, typically by moving in a counter (i.e., opposite) direction to the direction of loading. In some variations, the mirror driver may also apply force to unload the bias. The mirror driver may include a magnet that is acted on by an electromagnetic coil (inducing an electromagnetic force acting on the magnet). Thus, the magnet of the mirror driver may be operatively connected to the bias (and/or the mirror), and the electromagnetic coil (e.g., a stator having a coil and a pole) maybe connected to the engine support. In some variations, the magnet is part of a rotor that is connected to the bias and the mirror. Force from the electromagnetic coil acts on the magnetic rotor to load (and/or unload) the bias, causing the mirror to oscillate. Thus, the mirror driver of the device may include an electromagnet.

In some variations, the mirror driver is selected from the group consisting of: a motor, a voice coil motor, a reciprocal electromagnetic driver, a piezoelectric driver, a solenoid, a liner solenoid, a magnetostrictive driver, and a MEMS driver.

As mentioned, the mirror and bias may move in an undamped fashion. Undamped motion means that the mirror and bias, when displaced, will oscillate in simple harmonic motion if released. Furthermore, the devices described herein may be said to have at least one resonant frequency. The resonant frequency of the device is the resonant frequency of the mirror and bias (and any additional displaceable components that may be attached thereto, such as a rotor). In some variations, the resonant frequency is between about 1 and about 1000 Hz (1 kHz). For example, the resonant frequency may be between about 40 and about 130 Hz.

The mirror may be further configured to project illumination produced by the light source to form an illumination pattern when the light source is activated and the mirror is moving at the resonant frequency.

Additional features may also be included to the devices and systems described herein. In particular, a light source may be used. Any appropriate light source may be used, including light sources selected from the group consisting of: a florescent bulb, an incandescent bulb, an LED, a halogen bulb, a flash lamp, a coherent light source (e.g., a laser), an IR lamp, a UV lamp, an optical cable, and a solar light source. Collimated or concentrated light is particularly useful, because it may be accurately directed by the mirror(s) of the resonant engine. Thus, a light source may include one or more collimating or concentrating elements (e.g., mirrors, lenses, reflectors, etc.). The light source may be attached to the engine support (e.g., housing) of the device, or it may be separate. For example, a light source may be separably positionable from the mirror-containing resonant engines (devices) described herein. Multiple light sources may be used with the same resonant engine. This may also permit the resonant engines described herein to be versatile, and adapted for use with a variety of light sources. Further, a single variation of a resonant engine may be simultaneously with different light sources. In some variations, a light source is integral to the device having the oscillating mirror(s). In some variations, an illumination device includes a mount for positioning the illumination device.

Any of the devices described herein may include a lens for modifying the light reflected by the mirror. For example, the light may be focused, diffused, color-shifted, etc.

Also described herein are methods for efficiently illuminating a wide pattern of illumination. For example, one variation of a method for efficiently illumination a wide pattern of illumination includes illuminating a light source, and moving a movable mirror at a resonant frequency to project light from the light source into a wide pattern of illumination. The resonant frequency is between about 10 and about 1000 Hz (e.g., in some variations, the resonant frequency is between about 40 and about 120 Hz).

In some variations, the method of illuminating a pattern of illumination includes the step of moving a mirror (which is part of a mirror system) at a resonant frequency for the mirror system, wherein the resonant frequency is between about 10 and about 1000 Hz. The mirror system typically includes a bias, operatively connected to the mirror, an engine support (wherein the bias is operatively connected to the engine support), and a mirror driver that is configured to load the bias and thereby drive movement of the mirror. The method may also include illuminating a light source to produce collimated and/or concentrated light, so that the collimated light from the light source is reflected from the moving mirror to produce a wide pattern of illumination.

Any appropriate pattern may be illuminated. For example, the pattern may square, oval, rectangular, rounded, curved or the like. The patterns of illumination resulting from the illumination devices described herein may be perceived by an observer to be equivalent to that of a larger static illumination source. In some variations, the width of the area of illumination corresponds to the angle of the excursion of oscillation of the mirror of the resonant engine device. Thus, the width of the area illuminated may be adjusted by adjusting the extent of the oscillation (excursion) of the mirror (e.g., ±10°, ±20°, ±30°, ±45°, etc.). In some variations, the height of the area illuminated may be adjusted by adjusting the shape and properties of the mirror.

Also descried herein are devices for reflecting light over a broad region. These devices may include a mirror configured to receive and reflect collimated or concentrated light from a light source. The mirror may be operatively connected to a rotor. These devices may also include a bias mounted to an engine support, wherein the bias is operatively connected to the rotor so that the mirror oscillates when the bias is loaded and unloaded by moving the rotor. In addition, these devices may include a stator connected to the engine support, wherein the stator is configured to act on the rotor and load the bias. As described above, any appropriate bias may be used.

In any of the devices described herein, the mirror may be any appropriately-shaped mirror, or plurality of mirrors. For example, the mirror may be bent, curved, peened, facetted, discontinuous or compound. In some variations, the mirror is configured so when it is oscillated to illuminate an area, the amount of time that reflected light is directed toward the edges of the area illuminated is greater than the time that the illuminated light is directed towards more central regions of the illuminated area. In some variations, the mirror is configured so that a single cycle of the mirror results in light from the light source being reflected across the illumination area multiple times or at multiple points. Thus, the mirror used may help determine the effective oscillation rate of the devices described herein. In some variations, the mirror is a bent mirror.

The devices and systems described herein may be powered by any appropriate power source, including batteries or wall current. In some variations, the power source is connected to the stator. The devices and systems described herein may include a power source (e.g., for powering the mirror driver). Examples of appropriate power sources may include: a fuel cell, a battery, a solar power source, an AC power source, a DC power source, an AC to DC converter, a DC to non DC converter, etc. Any of the devices and systems described herein may also include additional mirrors (e.g., a second mirror). The second mirror may be a movable mirror or a fixed mirror).

As described above, the any of the devices described herein may be used with one or more light sources, particularly collimated light sources, or light sources configured to provide collimated or concentrated light. In some variations, the light source is independent from the reflecting device for illuminating a broad region. For example, the light source may be separately adjustable or positionable with respect to the oscillating reflective device. In some variations, the light is integral to the reflective device.

The devices described herein may also have a cover for the engine support, particularly when it is configured as a housing. At least a portion of the mirror may be positioned outside of the region enclosed by the cover and housing. The housing and cover may enclose and protect the bias, and at least a portion of the rotor. The rotor may project out of the housing and include a mounting region for attaching or securing the mirror.

In some variations, the devices and systems described herein include one or more control circuits (or control circuitry) for controlling the energy applied to the stator to act on the rotor. For example, printed circuit board (PCB) may be included (e.g., within the housing). The control circuitry may be connected to one or more sensors. Thus, any of the devices and systems described herein may include one or more sensors. Sensors may monitor the motion of the mirror (and or the rotor), and may help control the oscillation of the mirror (or subassembly). For example, the sensor(s) may provide feedback to the control circuit. The control circuit may help operate the device so that the mirror oscillates at or near a resonant frequency.

Also described herein are systems for illuminating an area. These systems may include any of the devices and components described herein, including the resonant engine devices. In some variations, the systems of include one or more light sources, mirrors, biases and/or one or more power sources.

The devices and systems described herein may be fixed (e.g., non-portable), for interior, exterior or other use. In some variations, the devices and systems described herein may be portable (e.g., hand-held) or mobile (e.g. mounted on a moving vehicle). These devices and systems may provide illumination of a wide area due in part to the characteristics of the human eye. For example, the mirror, moving efficiently at or near mechanical resonance, can redirect the discharge of the illumination source to optimally illuminate an area using a light source that would otherwise be insufficient. Alternating current, direct current or discontinuous current may be used to drive any of the components of the illumination system, as described more fully below.

The details of one or more embodiments of these light sources, illumination systems, and/or methods of using them are set forth in the accompanying drawing and in the description below. Other features, objects, and advantages of the invention will become apparent from the description and drawings, and from the claims.

These devices and systems described herein may provide continuous illumination of a wide area, due in part to the characteristics of the human eye. Psychotropic properties of the human visual system make it unable to detect light motion beyond a certain frequency. Thus, movement of a light source may yield the perception of continuous light, or of a higher perceived intensity of light, or other effect.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A shows an illumination pattern of a typically static device. FIG. 1B shows an illumination pattern for a device in which the light from the light source is scanned as described herein.

FIGS. 2A and 2B show schematic cross-sections through a variation of an illumination device as described herein

FIG. 3 shows one arrangement if a resonant illumination system in which multiple mirrors are used.

FIG. 4 shows an exploded three-dimensional view of an illumination device as described herein.

FIG. 5 illustrates a cross-section through the middle of an illumination device similar to the one shown in FIG. 4.

FIG. 6 shows a partial cross-sectional view of an illumination device similar to that shown in FIGS. 4 and 5.

FIG. 7 shows a schematic of an illumination device having an elongated light source (e.g., bulb) and a mirror with a parabolic reflective surface reflecting light from the light source, as described herein.

FIGS. 8A and 8B illustrate another variation of an illumination device as described herein.

FIG. 9A shows a block diagram of one variation of a resonant engine.

FIG. 9B shows a schematic of a resonant engine system.

FIG. 10 is one variation of a resonant engine.

FIGS. 11A-11C show one variation of a bias, configured as a clock spring.

FIGS. 12A-12B show a clock spring to which a rotor is attached.

FIGS. 13A-13D show schematic illustrations of components of a resonant engine, similar to that shown in FIG. 10.

FIGS. 14A-14C show perspective, top and side cut-away views, respectively, of a portion of a resonant engine.

FIGS. 15A-15C is another variation of a resonant engine.

FIG. 16A is one example of a profile of mirror for use with a resonant engine.

FIGS. 16B-16D illustrate scanning of the mirror shown in FIG. 16A.

FIG. 17A is one example of a profile of mirror for use with a resonant engine.

FIGS. 17B-17F illustrate scanning of the mirror shown in FIG. 16A.

FIG. 18A is one example of a profile of mirror for use with a resonant engine.

FIGS. 18B-18F illustrate scanning of the mirror shown in FIG. 16A.

FIGS. 19A-19B illustrate another variation of a resonant engine.

FIG. 19C is an exemplary drive signal for a resonant engine as shown in FIG. 19A-19B.

FIGS. 20A-20B illustrate the operation of a resonant engine such as the resonant engine shown in FIGS. 19A-19B.

FIGS. 21A and 21B show top and side perspective views, respectively, of a mirror that may be used as part of a resonant engine.

FIG. 21C illustrates a reflection pattern for the mirror shown in FIGS. 21A-21B.

FIGS. 22A and 22B show top and side perspective views, respectively, of a mirror that may be used as part of a resonant engine.

FIG. 22C illustrates a reflection pattern for the mirror shown in FIGS. 21A-21B.

FIGS. 23A and 23B show top and side perspective views, respectively, of a mirror that may be used as part of a resonant engine.

FIGS. 24A and 24B show top and side perspective views, respectively, of a mirror that may be used as part of a resonant engine.

### DESCRIPTION OF INVENTION

Described herein are devices, systems and methods for providing area illumination by resonant oscillation of one or more mirrors. Such devices, systems and methods may offer enhanced illumination with minimal power consumption. These devices may be referred to as “resonant engines,” “resonant lighting,” or “resonant engines for adjustable light.” Thus the systems may be referred to as “R.E.A.L” systems (“resonant engines for adjustable light” systems) or resonant engine systems.

In general, the devices described herein include a mirror (or multiple mirrors) that is mounted to a bias. The mirror and bias may form a mirror subassembly that is attached to an engine support (e.g., housing). The mirror subassembly may include additional components (e.g., a rotor or other portion of the mirror driver), and is typically mounted so that it may be moved (e.g., oscillated) in a substantially undamped fashion continuously at or near the resonant frequency of the mirror subassembly. The mirror subassembly may be a single (unitary) component. For example, the mirror and subassembly may be the same component. The devices may also include a mirror driver that provides force to load and unload the bias and move the mirror(s). The mirror driver may also be mounted to the support. The mirror driver may be configured to provide force to move the mirror (or mirror subassembly) at or near a resonant frequency of the mirror and bias combination. In some variations one or more control circuits is included to control the force applied by the mirror driver so that the mirror and bias are moved at or near a resonant frequency and the desired magnitude for the mirror and bias. In some variations, one or more sensor(s) may provide input to the control circuit.

A light source may also be included, either as part of the resonant engine, or as part of a system including the resonant engine. Light from the light source may be reflected by the resonant engine to form a pattern as the resonant engine moves the mirror. The emissions of the light source (or illumination source) are typically guided by the mirror, which moves in an energy-efficient mechanically resonant fashion, directing the emitted light toward a target or in a desired direction, creating an illumination pattern. This larger illumination pattern is formed by the rapid movement of smaller discrete spots, bars or other shapes of illumination, but will typically be seen by an observer as illumination of the entire larger area, and as equivalent to the illumination generated by a higher power illumination source directed over the same area.

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded a scope consistent with the appended claims.

As used herein, the term “mirror” may refer to any appropriate reflective surface. A mirror may be a flat or substantially flat reflective surface, or a curved, elliptical, parabolic, rounded, off-axis, bent or facetted surface. In some variations, the mirror is only partially or selectively reflective. The mirror may be a compound mirror, and may have multiple facets or faces. Examples and further descriptions of mirrors are provided below.

As used herein, the term “bias” may refer to any appropriate element to which may be displaceable, flexible, and/or elastic. Typically, a bias may store mechanical energy during loading when it is moved from a first position, and then release the mechanical energy during unloading when it returns towards the first position. A bias may be an elastic material or a structure having elastic properties (e.g., elasticity or resilience). For example, a bias may be selected from the group consisting of: a spring, an electrometric band, a string, a plastic member, a rubber member, a metal member, and a composite member. One particular example of a bias is a clock spring.

As used herein, the term “light source” may refers to any appropriate source of light, particularly electrically-activated light sources such as lamps, light bulbs, LEDs, coherent light sources, flash lamps, etc. The devices described herein may also be referred to as light or lighting devices, and may be part of an illumination system or light system. The resonant engine devices described herein may be fixed or mounted (e.g., configured to be attached to a surface or object), or they may be hand-held devices, and may be used in any application in which illumination would be useful, particularly in applications in which low-power, wide-range illumination would be useful.

As used herein, the term “engine support” may refer to a support that secures at least one portion of the mirror subassembly, and does not substantially move with respect to the mirror subassembly. In some variations, the engine support is a housing, and may also enclose one or more portions of the device. In some variations, the support is a framework (e.g., a rigid framework) or scaffolding. The support may not fully enclose any portion of the device. An engine support may be mountable in order to fix the device in place, or may include a stand or base for positioning the resonant engine. Although the term “housing” is used throughout this description, it should be clear that any of the embodiments referred to as including a “housing” may instead (or in addition) include the more general “engine support.”

The devices described herein typically include a mirror and may be used with (or may include) a light source. In most variations, the light source does not move with respect to the mirror, while the mirror is capable of moving at a resonant frequency. Resonance is the tendency of a system to absorb more energy when the frequency of its motion (e.g., oscillation or vibration) matches the system's natural frequency of vibration (its resonant frequency) than it does at other frequencies. The resonant frequency of the mirror and bias may be determined based on the materials used to form them, and their arrangement, and may be calculated or determined experimentally. There is usually a “family” of resonant frequencies for the mechanical system of the illumination device (e.g., harmonics). In general, the illumination devices described herein may move the mirror at a resonant frequency that is greater than the average threshold for detection of “flickering” by the unaided human eye. For example, a typical eye can detect flickering (temporal separation) of an equal intensity light source at intervals as low as 15-25 ms (e.g., app. 40-60 Hz).

Thus, in some variations, it may be desirable to configure the device to operate at a resonant frequency that is greater than (or equal to) the threshold for detection of “flicker” so that the area illuminated by the illumination device appears as solid to an observer. The resonant frequency at which the device operates may be determined based on the intended use for the device or the environment in which the device operates. For example, a handheld device may typically be operated at a resonant frequency between about 10 to 60 Hz (e.g., approximately 40 Hz). A fixed illumination device (e.g., a non-handheld device) may be operated at a slightly higher resonant frequency, e.g., between about 60 and 120 Hz. (e.g., approximately 72 Hz). As described below, the operational (e.g., resonant) frequency may be configured based on the power source (e.g., AC current), and may be adjusted by adding spring components, dampening components, or other modifying elements.

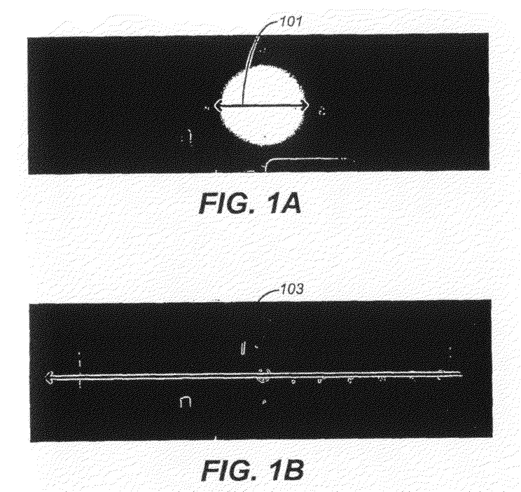

FIGS. 1A and 1B illustrate a proof-of principle of a device as described herein. In FIG. 1A a light source having a circular beam pattern (a spot) is projected directly on a target surface, shown as a calibrated wall. The beam pattern has a diameter 101 that is fixed by the optics of the light source. In FIG. 1B the same light source is used in conjunction with a resonant engine (not shown) having a mirror and a bias, and a mirror driver that oscillates the mirror at or near a resonant frequency of the mirror and bias. The spot is projected onto the moving mirror. The mirror is oscillating abound a neutral position (e.g., 0°) through a positive and negative angle of deflection, which may be based on the bias (e.g., ±45°). As a result, the spot of light from the light source is effectively scanned over the target. The frequency of oscillation of the beam of light (for this single mirror example) is equivalent to the frequency of light of the oscillation of the mirror. The result is a perceived illumination pattern on the target that is a field of view having a much larger diameter 103 than the static spot 101 shown in FIG. 1A. The mirror and bias (or mirror subsystem) may be moved in a very energy-efficient manner by driving them at or near resonance.

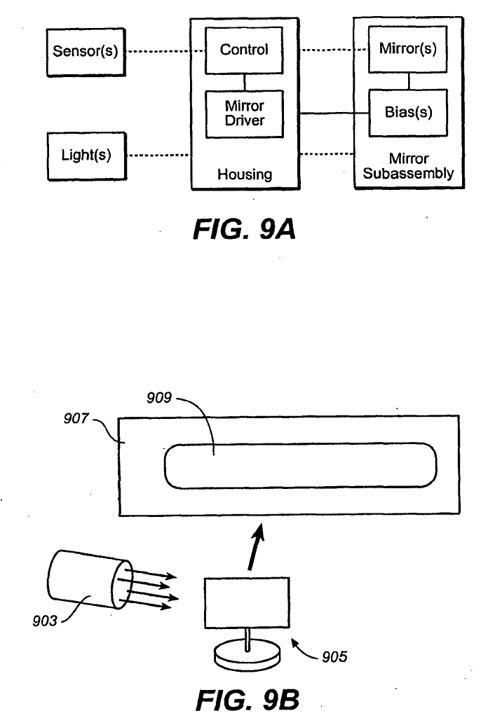

FIG. 9A shows a block diagram describing the relationship between some of the elements that may be included in the resonant engine devices and systems for illumination described herein. As mentioned above, a resonant engine may include a mirror (or mirrors) coupled to a bias, as indicated by the solid line. The mirror and bias may form a mirror subassembly. At least a portion of the mirror subassembly may be mounted to a housing. In general, the mirror is operably connected to the bias, and the bias is connected to the housing (thus, the mirror is connected to the housing through the bias). In some variations, the mirror is included within the housing, while in some variations the mirror is not located within the housing.

A mirror driver may also be included within the housing. Examples of mirror drivers are provided below. In general the mirror driver applies force to load and/or unload the bias. In particular, the mirror driver may apply force so that the mirror subassembly oscillates in resonance. The mirror driver may be controlled by a controller, as indicated by the solid line between the two in FIG. 9A. The controller may include control logic for controlling the power applied to the mirror driver, or for otherwise regulating the force applied to the bias by the mirror driver. In some variations the controller receives input from one or more sensors that feed back into the controller to help regulate the force applied by the mirror driver, thereby helping the mirror subassembly to move at or near resonance. For example, motion of the mirror subassembly may be monitored by an optical sensor. In some variations, a sensor may monitor the load seen by the mirror driver when driving the mirror subassembly. In some variations, a magnetic or magnetic pick-up sensor may be used. Control logic may use this information as feedback to regulate the force applied by the mirror driver.

As mentioned above, one or more lights may also be included as part of the system or device. For example, a light may be included within the housing.

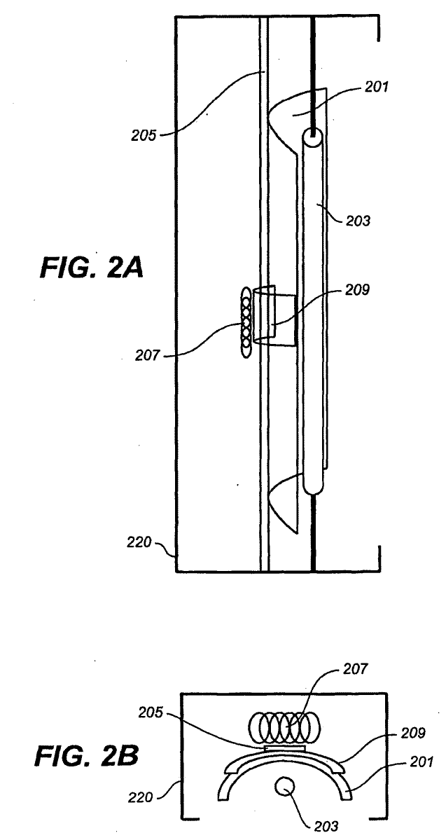

Various examples of resonant engines and resonant engine systems for illuminating an area are described below, including additional detail about each of the components shown schematically in FIG. 9A. Additional elements may also be included, such as (but not limited to) mounting brackets, lenses, filters, power supplies, bearing(s), alignment components, windings, circuitry or the like. In some variations, the resonant engine includes one or more light sources as part of the resonant engine, or a system including a resonant engine. This is illustrated in FIGS. 2A-7.

FIGS. 2A and 2B show schematic cross-sections through a variation of a resonant engine device having a light source integral to the resonant engine, and within the housing of the device. In FIG. 2A the light source 203 is an elongated bulb (e.g., a linear fluorescent bulb, a linear halogen bulb, a linear incandescent bulb, flash lamp, an array of LEDs, etc) that is fixed to a housing 220. The light source may be fixed directly to the housing, or it may be attached to a stem or other positioning device to position the light source with respect to the mirror. The arrangement of the light source and mirror is described more fully below. FIG. 2B shows the same device shown in FIG. 2A in cross section through the center of FIG. 2A.

The device shown in FIGS. 2A and 2B also includes a mirror driver configured to move the mirror and thereby project light in a desired illumination pattern (e.g., illuminating a broad area). In this example, the mirror subassembly includes a bias 205 (e.g., a spring) attached to the mirror 201. A mirror driver 207 which allows the mirror to move with respect to the housing 220, includes a magnet 209 attached to the back of the mirror 201, and an electromagnetic coil 207 opposed to the magnet 209. The mirror subassembly is free to oscillate within the housing 220 because either (or both) ends of the bias are attached to the opposite ends of the housing 220 in this example. In operation, the electromagnetic coil 207 can be excited by electrical current to create a magnetic field that interacts with the magnet 209 to load the bias 205 and thereby move the mirror 201 around the light source 203, projecting the light from the opening in the housing 220 in the process. The bias (e.g., an elastic member) is configured to move or twist as the magnetic field applies force. The bias may then return the mirror back to the original (neutral) position by turning off the magnetic field, or by altering the polarization of the magnetic field. The motion of the mirror may be guided by the bias 205. The electromagnetic coil acts on the magnet and imparts torque (or moment) to move the mirror, pushing against the bias. The bias exerts a restoring torque in the opposite direction to guide the mirror as it moves back to the starting position. In this example, energy may be saved when oscillating the mirror rapidly, because the bias may be used to store some of the mechanical energy required to displace the mirror, and this stored energy may be released to unload the bias and push the mirror past the neutral position.

Although this example shows a mirror driver comprising a magnetic coil interacting with a magnet (or paramagnet) mounted to mirror (e.g., by gluing, etc.), any appropriate mirror driver may be used, and the components of the mirror driver may be arranged in any appropriate fashion. For example, the mirror maybe moved by other mechanisms (e.g., by pneumatic, hydraulic, etc.). In some variations, the mirror is biased in one direction (e.g., by a spring or springs) and force is applied against the bias. Other examples of mirror drivers may include (but are not limited to) motors, voice coil motors, reciprocal electromagnetic drivers, piezoelectric drivers, rotary solenoids, linear solenoids, etc.

In one variation, the mirror, or a portion of the mirror, is itself a magnetic or paramagnetic. Thus, a magnetic field may “push” or “pull” the mirror to cause the movement. The mirror is attached to the illumination device housing 220 by the bias (as show in FIG. 2A), or it may be connect to a pivot (e.g., an axel, rocker, etc.) about which it moves within the housing. The bias may be any appropriate structure for storing and releasing mechanical energy imparted to move the mirror. For example, the bias may be a spring or a material or structure having elastic properties. The bias may be a leaf spring, a coil spring, etc. The bias may be any appropriate material (e.g., elastic materials, metals, rubbers, polymers, etc.). The bias may be selected or modified to control the resonant frequency of the mirror movement. For example, the resonant frequency may be modified by increasing or decreasing the elasticity of the bias by changing the shape, weight, force, tension, load or position of the bias, including the position of attachment to the housing or to the mirror or another element functionally connected to the mirror.

The housing 220 may be any appropriate shape. The resonant engine device housings may include attachment sites for one or more light sources, as well as electrical connections for providing power to the mirror driver(s) and any light sources. The housing may includes an opening or a light-permissive (e.g., transparent) opening to allow the light to enter and/or exit the housing. In some variations, the inner walls of the housing may also be reflective, or may include additional mirrors for guiding the light emitted by the light source onto the movable mirror or otherwise out of the housing. The housing may be shaped to contain the light source and/or mirror, and may be adapted for mounting, attachment, or handheld use.

Any appropriate mirror or reflective surface may be used as part of a resonant engine. The mirror typically comprises at least one reflective surface, which may be completely reflective or selectively reflective. The mirror may be any appropriate reflector (including curved reflectors). In some variations, the mirror is made of a reflective material. In some variations, the mirror includes one or more reflective coatings. The shape of a particular mirror used as part of a resonant engine may be coordinated with the light source to optimize the perceived illumination pattern and/or the rate of scanning of the illumination source over the target illumination pattern. For example, a mirror having two or more reflective surfaces directed to illuminate the target area may effectively double the scanning rate. In this case, for every single oscillation of the mirror subassembly, two or more beams of reflected light are moved to form the perceived illumination pattern.

The “perceived illumination pattern” refers to the pattern of light (illumination) cast by the device in operation, as seen by a person using the illumination device. In general, the perceived illumination pattern covers the entire region over which the light from the light source is reflected. For example, in some variations, an oval or approximately rectangular perceived illumination pattern is projected by the illumination device (e.g., See. FIG. 1B). It is referred to as a “perceived” illumination pattern because the pattern is only perceptible when scanned, since it is formed only by the oscillation of the resonant engine's mirror subassembly.

In some variations, the mirrors may be flat, while in other variations, the mirrors may be concave (e.g., may have a parabolic cross-section), allowing focusing and projection of the light emanating from the nearby light source. A parabolic mirror may focus and project light from the light source due to the geometric properties of the paraboloid shape. For example, if the angle of incidence to the inner surface of the mirror equals the angle of reflection (as is usually the case), then any incoming light that is parallel to the axis of the mirror will be reflected to a central point, or focus. Parabolic mirrors can thus be used to collect and concentrate light, or similarly diffuse light. Energy radiating from the focus can be transmitted outward in a beam that is parallel to the axis of the mirror's concavity. As mentioned above, compound mirrors, having multiple reflective surfaces, may be used. A compound mirror may include both curved and flat surfaces.

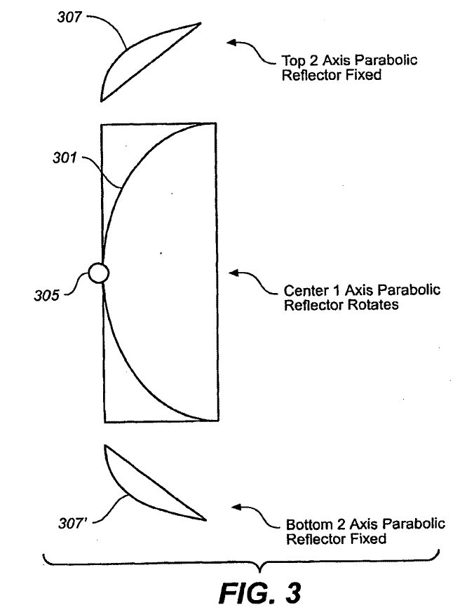

In some variations of the resonant engine in which a light source is included, the mirror may at least partially enclose the light source (e.g., partially surround it). Multiple mirrors may be used with the resonant engine, including mirrors or reflective surfaces that are not part of the movable mirror subassembly. In some variations, a combination of movable and immobile (relative to the housing) mirrors may be used. For example, a fixed mirror may be used in addition to a movable mirror, to capture light that the movable mirror misses, and project this light from the illumination device (or onto the movable projector and out of the illumination device). FIG. 3 shows one exemplary arrangement in which multiple mirrors are used.

In FIG. 3 a fixed central parabolic mirror 301 moves back and forth around a central region 305 to project light in a wide-angle perceived illumination pattern. Two additional mirrors 307, 307′ are included at either side of the central mirror. These additional mirrors are also curved, so that light is projected back into the central mirror 301. Thus, a movable mirror may be at least partially surrounded by a fixed mirror (or mirrors) to prevent additional loss of the light.

A secondary (or third, fourth, fifth, etc.) mirror may also be used. The secondary mirror may be placed separate from (e.g., around) the primary moving mirror, and may be designed to achieve an optimal illumination pattern or optimal distribution of light at a target. In some variations, multiple mirrors may be moved separately. For example, in some variations some of the mirrors are in resonant movement wile others are fixed (e.g., relative to the housing). A multi-mirror system may be used to achieve an optimal pattern or optimal distribution at the target. In some variations, multiple illumination patterns are achieved using a multiple mirrors in which different mirrors are all are in resonant movement. The resonant movement may be in different directions or at different resonant frequencies. Mirrors may be positioned and/or moved to achieve an optimal pattern or optimal distribution of the illumination pattern at multiple targets.

A resonant engine device or system may also include multiple light sources. Thus a single resonant engine device may include a plurality of light sources and/or a plurality of movable mirrors. The same movable mirror may be used with more than one light source. As described above, more than one mirror may be used with a single light source. In one variation, a single resonant engine device may project a perceived illumination pattern in which a first light source is projected in one direction at a resonant frequency and a second light source is projected in another direction at a resonant frequency. These lights may be projected in overlapping or non-overlapping patterns. For example, the light may be projected in complimentary patterns, thereby enhancing the intensity of the perceived illumination pattern while reducing any scanning artifacts. In some variations, light may be projected over a predetermined (or adjustable) angle. For example, a resonant engine may project light over 60°, over 90°, over 120°, over 180°, over 270°, or over 360°.

In some variations, the resonant engine may be used to achieve dimming and color mixing. For example, a light source of one color may be scanned over a target area using a resonant engine and a second light source of a different color may be scanned over the target area with a different resonant engine, or the same resonant engine (using same or a different mirror). If two or more resonant engines are used to illuminate the same area, the resonant engines may be coordinated. For example, the resonant engines may be linked or otherwise synchronized. Thus, each color may be scanned at a different rate and/or over a different area to achieve different color dimming and color mixing. As will be understood, there are numerous ways that dimming and/or color mixing may be achieved. For example, the power to the different light sources may be modulated, the scan rates of the mirror(s) reflecting the different lights may be modulated differently, or both. Other methods to achieve dimming and color mixing are known, including Pulse Width Modulation (PWM) schemes such as that set forth in U.S. Pat. Nos. 6,618,031, 6,510,995, 6,150,774, 6,016,038, 5,008,595, and 4,870,325, all of which are incorporated herein by reference as if set forth in their entirety. PWM schemes pulse the LEDs alternately to a full current “ON” state followed by a zero current “OFF” state. The ratio of the ON time to total cycle time, defined as the Duty Cycle, in a fixed cycle frequency may determine the time-average luminous intensity. Varying the Duty Cycle from 0% to 100% correspondingly varies the intensity of the LED as perceived by the human eye from 0% to 100% as the human eye integrates the ON/OFF pulses into a time-average luminous intensity.

In many of the examples described herein, the mirror is moved by rotating or translating the mirror with respect to a light source, which is typically fixed. However, many of these same principles described herein also apply to resonant engine devices in which a light source moves with (or in addition to) the mirror. For example, some types of bulbs (e.g., MR16, MR11, LED's with optics, etc.) include attached mirrors. In some variations, these light sources may be moved in addition to the mirror. Thus, the mirror subassembly may include a light source.

In operation the mirror subassembly typically moves with respect to the housing at a resonant frequency, and thus the mirror may be configured to move in a substantially undamped fashion, reducing the energy required to move it. In general, this means that the mirror subassembly is fixed (e.g., connected to the housing) at only one or two points. Further, the mirror may comprise a light weight material (e.g., metal alloys, plastics, etc.). The reflective surface may be a coating, or the entire mirror may comprise a reflective material. Thus dampening effects due to contact between the mirror subassembly and other components may be minimized.

Although many of the variations described herein include stiff or somewhat stiff movable mirrors which move with respect to the light source and/or housing, the movement of the mirrors (e.g., directing the light from the illumination source in a perceived illumination pattern) may alternatively (or additionally) be achieved by modulating the shape of the mirror as well. For example, a reflective material (e.g., foil, paper, etc.) may be bent, twisted, shaped, or otherwise manipulated to project the light from the device to help form the perceived illumination pattern.

The arrangement of the light source and the movable mirror subassembly may be chosen to optimize the distribution and intensity of light emitted by the illumination device. For example, mirrors such as parabolic mirrors or mirrors with additional lenses or lens properties (as described below) may have a focus from which light is concentrated and projected to form the perceived illumination pattern. The movable mirror and light source may be arranged so that the light source is offset from the focus of the light mirror. In particular, the mirror may be positioned so that the light source is closer to the mirror than the focus (or plane of focus). In addition, the light source is may be arranged so that it does not interfere with the range of motion of the movable mirror or the projected illumination pattern.

Additional elements may be included for shaping or conditioning the perceived illumination pattern. For example, optical features such as optical lenses may be included. A lens (or lenses) may be used to focus and/or defocus light projected from the resonant engine device. A lens may help “spread” the light projected from the light source so that it more uniformly illuminates the illumination pattern. Texture, pattern or peen may also be applied to the mirror to achieve a more uniform illumination of the perceived illumination pattern. “Peen” typically refers to a dotting or machining process that pits the surface of the mirror to soften or diffuse the reflected light.

A perceived illumination pattern may be non-uniform in intensity when the light emitted by the illumination device is moved or oscillated uniformly. This non-uniformity of illumination may be desirable or undesirable based on the lighting application. For example, refer back to FIGS. 1A and 1B to compare the illumination pattern of the static light source (shown in FIG. 1A) to the illumination pattern provided by the same light source used with a resonant engine device in which the light is scanned (as shown in FIG. 1B). The region illuminated by the scanned light 103 in FIG. 1B is many times larger than the un-scanned illumination 101 in FIG. 1A, however the field may be non-uniform in intensity due to the rate and pattern of oscillation of the resonant engine. In the example shown in FIG. 1B, the mirror and light are moved at a constant rate, approximately equal to the resonant frequency of the illumination device (e.g., back and forth along a single axis).

The perceived illumination pattern in FIG. 1B appears to have a non-uniform intensity, resulting in a somewhat barbell-shaped (or batwing-shaped) pattern in which the regions at either end of the illumination pattern appear slightly brighter (and therefore larger) than the regions in the middle of the pattern. When the mirror subassembly is oscillated back and forth at a constant (or approximately constant) frequency, the mirror (and/or light source) appears to change direction at the ends of the perceived illumination pattern. The time between periods of illumination at the end regions therefore has a different interval than the regions closer to the middle of the pattern. At lower frequencies this apparent difference in the time interval between illumination of the same area may result in an apparent difference in the uniformity of the illumination pattern.

The resonant engine may correct for this non-uniformity by changing the frequency or rate that the mirror is moved (in particular, by increasing the rate), or by changing the pattern in which the mirror is moved. For example, the resonant engine may be scanned in two dimensions (e.g., up-down, and side-to-side). In some variations, a desired illumination effect is achieved by modifying the mechanical system to create a more linear or continuous movement. For example, the resonant engine may include an additional bias that is extended at or near the ends of the range of motion, where the mirror changes direction. The additional bias feature may alter the speed that the mirror through the extreme end regions. These secondary mechanics may modify the mirror movement to achieve an optimal pattern or optimal distribution at the target.

The mirror subassembly may be moved in two-dimensional resonance. For example, a two-dimensional mirror movement can be used to achieve a more uniform, special shape or larger illumination pattern. In some variations, the mirror is moved in three dimensional resonances. Movement of the mirror (or mirrors) in three dimensional motion may further help achieve an optimal pattern or optimal light distribution pattern.

In general, the mirror (or other movable portions of the resonant engine, such as a light, a lens, or additional mirrors) may be moved or oscillated in any appropriate manner. As described above, a mirror may be moved in one dimension (e.g., oscillating back and forth or up and down), in rotation, in two dimensions (e.g., any combination of back and forth, up and down, rotation, etc.) or in three dimensions (including in and out). Each dimension of motion may be separately controlled (e.g., using an individual mirror driver), or may be driven by the same mirror driver. Each dimension of motion may be controlled to regulate the perceived illumination pattern.

Optical features such as lenses may also be included as part of the resonant engine. Lenses may be used to help distribute the light over the illumination pattern. For example, the resonant engine may include a lens which is particularly helpful for diffusing the illumination pattern (e.g., widening it, or minimizing non-uniform intensity). A lens may be attached to the mirror, or it may be separate from the mirror. In some variations, the lens may be attached to the housing. In some variations, the lens may move with the mirror, or independently of the mirror. A lens may be placed between the light source and mirror or between the mirror and target. More than one lens may be used. A lens may also be used to help focus light from the light source. Other optical features may also be used. For example, a lens may be used to polarize or filter light from the light source.

Any of the light sources referred to herein may be collimated and/or highly concentrated light sources. Collimated light may be particularly desirable. In general, collimated light is light in which the light rays are parallel, and may therefore have a plane wavefront. Light can be collimated by a number of processes, including shining it on a parabolic concave mirror with the source at the focus. Collimated light is sometimes said to be focused at infinity. In some variations, coherent light may be used (e.g., light from a laser source). In some variations, coherent light is excluded.

The resonant engines described herein may use light sources that emit light of any appropriate wavelength and/or intensity. For example, the light source may be a traditional light source (e.g., an incandescent, florescent, halogen, etc.), an infrared light source, an ultraviolet light source, a heat lamp, or some combination thereof.

The lighting source may be fixed (e.g., relative to the resonant engine or to the housing of the resonant engine) or it may be movable. For example, the lighting source may be movable separately from the movable mirror. In some variations the resonant engine is adapted to be used with an existing light or lamp. Thus, the resonant engine may retrofit an existing light or lamp. In some variations the resonant engine may include an adapter to direct light from an existing lamp or illumination source towards the mirror (or mirrors) of a resonant engine. This adapter may include a lens or other collimator.

In some variations, a resonant engine may also improve energy efficiency by allowing a light source to be powered by discontinuous power. For example, the discontinuous power may be generated as an interrupted DC signal having a duty cycle or a non DC waveform (e.g., an AC waveform). The frequency that power is supplied to the light can be chosen at or above a predetermined frequency so that the light source is “on” long enough to be perceived without “flicker,” as described above for the movement of the mirror. Desired light distribution may also or additionally be achieved by modulating intensity of the light source(s). Such effects can be gained through fast response solid state lighting (e.g., LEDs) or through the use of multiple lamps. Modulation of the intensity may be relative to the resonant frequency of the resonant engine to create a desired effect and/or desired light distribution.

In variations in which the mirror (or light source) is moved at a resonant frequency, the rate or frequency of the power applied to the light source may be coordinated with the rate of movement. The frequency that power is supplied to the light source (the light power frequency) may be coordinated or modulated with the rate of movement of the mirror (e.g., the movement frequency) so that the apparent illuminated field is more uniformly illuminated. For example, the two frequencies may be timed so that the light source is “on” more when the mirror is aiming the light source in the center of the illumination field, compared to the edges (which may otherwise receive almost twice as much light). The discontinuous power supplied to the light source may therefore be “on” more than it is “off”, or may be “on” for different periods or intervals. For example, the discontinuous power supplied is not limited to sinusoidal signals (e.g., the duty cycle may be greater than 50%). In some variations, the power to the light source is modulated in time relative to the timing of the resonant system (e.g., matched to the resonant frequency or harmonics of the resonant frequency).

The frequency of power to the light may be related to the frequency of oscillation of the mirror subsystem. In some variations, the light power frequency is regulated by the frequency that power is applied to move the mirror. In some variations, the frequency that power is supplied is regulated by the supplied power (e.g., AC current). In addition to reducing the total power required to operate the resonant engine, regulating the power applied to the light source may also extend the lifetime of the light source.

Resonant engines in which the mirror does not move may also be used. For example, it may be beneficial to improve the energy usage of a static resonant engine by applying discontinuous power to the device. Furthermore, discontinuous power may be applied to resonant engines where the light source and the mirror both move, or where the light is fixed but the mirror subassembly moves. For example, the light may be pulsed or strobed. The power supplied to move the moveable portions of a resonant engine may also be regulated. For example, the power supplied to move a moveable mirror at resonance may be supplied from the alternating frequency power commonly available from utility companies. Thus, the resonant frequency source may be based on directly adapting the frequency of this wall current. For example, alternating current generated by most utility companies typically comprises a very stable 50 hertz or 60 hertz component. This frequency component can be utilized to effectively move a mirror. As described herein, the mirror may moved by a mirror driver that includes a motor, a voice coil motor, a reciprocal electromagnetic driver, a piezoelectric driver, a rotary solenoid, a linear solenoid, or any other appropriate component.

In general, any appropriate power source or supply may be used, including DC energy sources (such as a battery, fuel cell, solar cell or similar energy generating device), and AC energy sources (e.g., wall current). The choice of power supply may depend upon the use or configuration of the resonant engine. For example, the resonant engine may be configured for exterior, portable and/or mobile applications.

Any of the resonant engines described herein may be part of an illumination system (i.e., a resonant engines for adjustable light system). Resonant engine systems may include an illumination source (e.g., a light source), a mirror configured to move at a resonant frequency, a bias, a housing, and/or any of the components described herein, including duplicate components such as additional mirrors and light sources. In some variations, the system includes a power supply or a power supply conditioner for adapting the power supplied to the light source, a movable mirror, or both.

Illumination systems may also include mounts or attachments for positioning or securing the illumination device to a surface or in a desired position. For example, the illumination source may be mounted to a tripod or stand. The illumination source may be mounted to a wall or rooftop.

Any of the devices or systems described herein may be used for any appropriate purpose, particularly when illumination of a large or controlled area requiring only low power would be beneficial. For example, the described resonant engines may be useful by protective service agents such as police and fire personal, for maintenance and laborers whom depend on illumination, or for automotive or mobile applications. The resonant engines described herein may be particularly useful where only limited power sources are available, or where the light source is important for safety or productivity.

In operation, the resonant engines described herein may be operated by one or more user controls. For example, a user control (e.g., switch, dial, button, etc.) may be present on the outside of the housing. A power switch may be provided to turn the device “on” or “off”. In addition, a user control may be provided to activate or regulate different portions of the resonant engine. For example, a user control may be provided to select or adjust the resonant frequency that the mirror (and/or illumination source) oscillates. Thus, in some variations, the resonant engine may be used in different modes, including a narrow-field mode (in which the mirror subassembly is not oscillating), a wide-field mode (in which the mirror subassembly is oscillating). In some variations, the width of the filed (e.g., the lateral extent to which the mirror subassembly moves during an oscillation) may be adjusted or controlled in one or more dimensions. This may be referred to as control of the scan angle of the illumination source. In some variations, a brightness control may also be included. The brightness control may regulate the power supplied to the light source, or may activate/deactivate additional light sources, or may selectively attenuate, or may modulate the brightness intensity in a manner synchronous to the resonant frequency, etc.

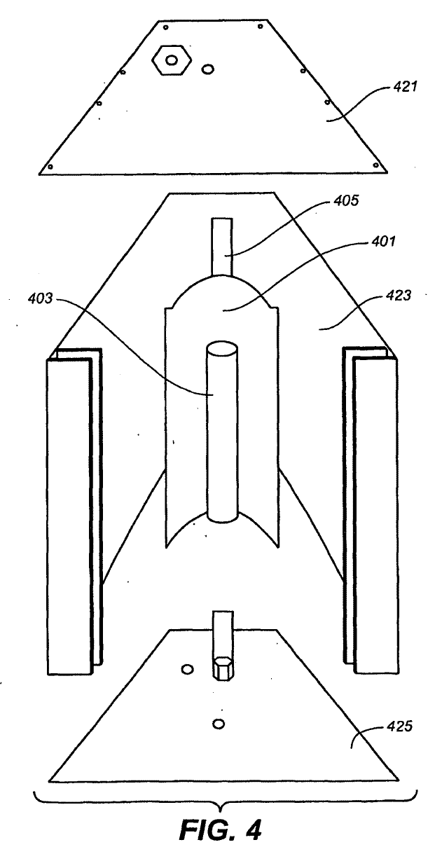

FIGS. 4-8 illustrate another variations of the resonant engines described herein. As mentioned above, these devices may be used as part of any illumination system, and may be used, for example, as stairwell lighting, hallway lighting, exterior sign lighting, Interior down lighting, shop light (e.g., when used with a tripod), or as part of consumer electronic lighting products.

FIG. 4 shows an exploded three-dimensional view of a resonant engine as described herein. In this variation of a resonant engine, the light source 403 is a linear bulb (e.g., a linear incandescent bulb) which is attached to the upper 421 and lower 425 walls of the housing 423, in front of the mirror 401. The mirror is configured to move at a resonant frequency (e.g., between 40 and 120 Hz). In operation, the mirror 401 moves around the light source 403 by flexing the bias 405. The bias (or spring) is attached to the mirror along the longitudinal midline of the mirror. Thus, the movement of mirror may be balanced, allowing maximum movement at the resonant frequency. The bias is also attached to the top and bottom of the housing. In some variations (not shown) the mirror may include stops which may limit the movement of the mirror and prevent damage to the light source by the motion of the mirror. In another variation, the stop may be elastomeric and accelerate the bias movement reshaping the beam pattern and or light distribution.

When assembled, the resonant engine shown in FIG. 4 has a rectangular opening through which the light may be projected to form the illumination pattern. This opening may be covered with a transparent surface (e.g., glass, plastic, etc.).

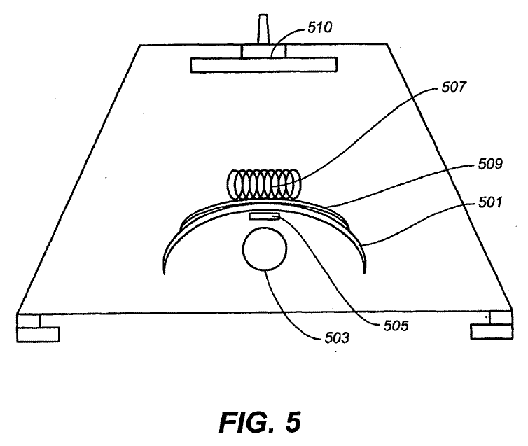

FIG. 5 illustrates a cross-section through the middle of a resonant engine similar to the one shown in FIG. 4. This resonant engine also includes a mount 510 for mounting the device to a wall, a stand, etc. The mount is located at the back of the device, opposite from the opening through which light is projected. The mount (or additional mounts) may be located in any appropriate location on the resonant engine. The cross-section shown in FIG. 5 also shows a mirror driver comprising an electromagnetic coil 507 which is configured to interact (e.g. apply electromagnetic force against) a magnet 509 or paramagnetic substance attached to the back of the reflective surface 501. Inducing an alternating magnetic field by the electric coil may “push” and/or “pull” the mirror, resulting in movement. As describe more fully below, movement of the mirror should optimally be performed at a resonant frequency.

In the arrangement shown in FIG. 5, the mirror is attached to a bias 505, shown located between the light source 503 and the mirror 501. The bias may be positioned in any appropriate position. In this example, the bias is located along a center (midline) of the mirror, as described previously, and is also located at focal point so that as the mirror rotates (e.g., by twisting or otherwise deforming the bias), the magnets or paramagnets mounted on the back of the mirror keep an adequate (or a constant) distance from the electromagnetic coil. The elements shown in the figures are not necessarily to scale. For example, the electromagnet coil may be more uniformly separated from the mirror and/or magnets.

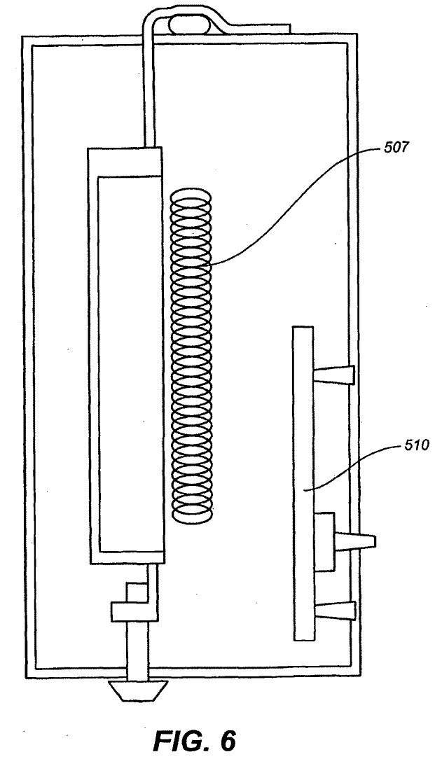

FIG. 6 shows a partial cross-sectional view of a resonant engine similar to that shown in FIGS. 4 and 5. This cross-section is taken through the long axis of the resonant engine.

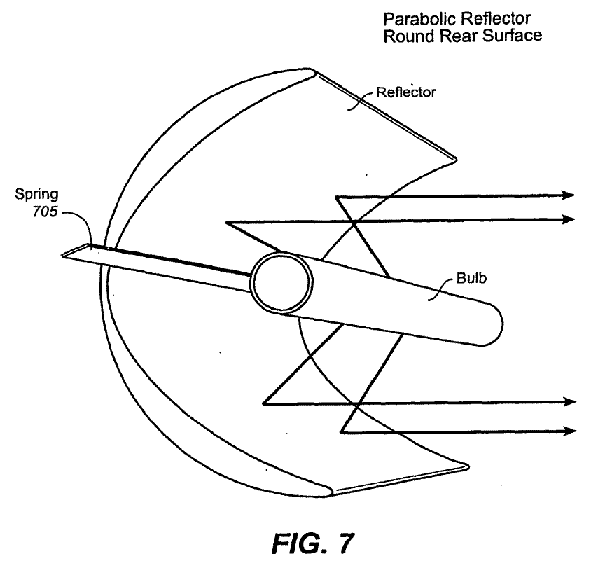

FIG. 7 illustrates a schematic of a resonant engine having an elongated light source (e.g., bulb) and a mirror with a parabolic reflective surface reflecting light from the light source. A bias (shown as a spring 705) is attached to the mirror at the longitudinal midline of the mirror. Thus, the mirror may be moved at the resonant frequency for this system (e.g., 50-130 Hz), as previously described, to produce an illumination pattern. In some variations, the bulb may be off during part of the movement cycle (e.g., when the mirror faces the extreme edge regions of the pattern), which may modify the illumination pattern (e.g., to minimize or reduce uneven illumination of the pattern).

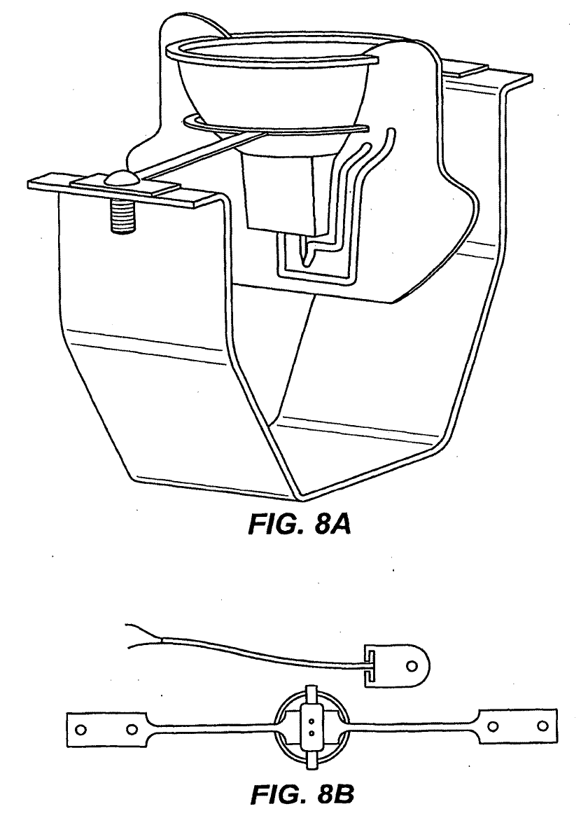

FIGS. 8A and 8B illustrate another variation of a resonant engine as described herein. In FIG. 8A, the resonant engine comprises a combined mirror and light source (e.g., a MRI 6 type bulb), which may be oscillated together to form the illumination pattern, as described above.

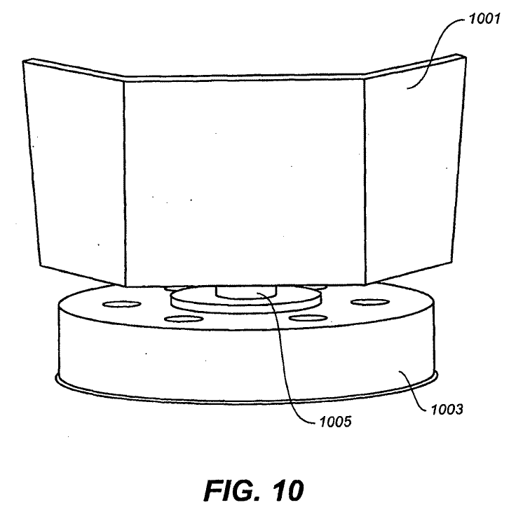

FIG. 9B shows a schematic of a resonant engine system. This system includes a resonant engine 905 (having a mirror, bias and mirror driver), and a light source 903. The light source provides collimated light that is directed towards the resonant engine. Collimated light from the light source is reflected off of the oscillating mirror of the resonant engine 905 against the target (screen 907), where it forms an illumination pattern 909. The particular variation of the resonant engine is shown in greater detail in FIG. 10.

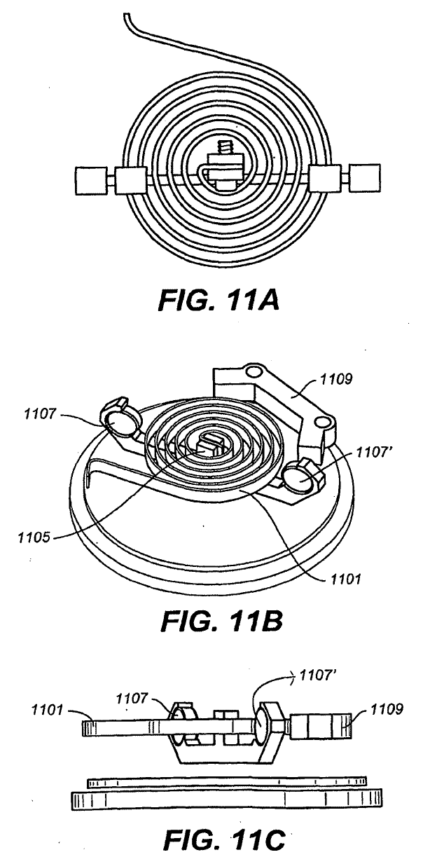

FIG. 10 shows a resonant engine that does not include a light, and has a mirror 1001 having three panels that are each flat and reflective (on at least one side). Each mirror panel is positioned at an angle with respect to the other. The mirror 1001 is attached to a rotor 1005 that is in turn connected to a bias (not shown) within the housing 1003. An external light (e.g., a collimated light as shown in FIG. 9B) may be positioned so that the emitted light reflects off of the mirrors when the mirror subassembly oscillates. Additional details for this variation of the resonant engine are described in FIGS. 11-14.

In some variations, including the device shown in FIG. 10, the bias is a spring, such a clock spring. FIG. 11A shows one variation of a bias configured as a clock spring. In general, a clock spring is a coiled spring, in which each coil nests inside the next larger one. A clock springs typically has two ends. The first end may be located at the center of the coils and may attach to a central shaft (i.e., a rotor) may be attached. The second end at the end of the outer coil may be mounded to the housing (or structure that communicates with the housing, to secure the spring within the housing. Typically, the clock spring exerts torsional force between the central shaft and the housing. Clock springs can be made from a variety of materials, including (but not limited to) metals, alloys, polymers, rubbers, or combinations thereof. For example, a clock spring may be made from beryllium copper or similar alloys, or high-carbon steel.

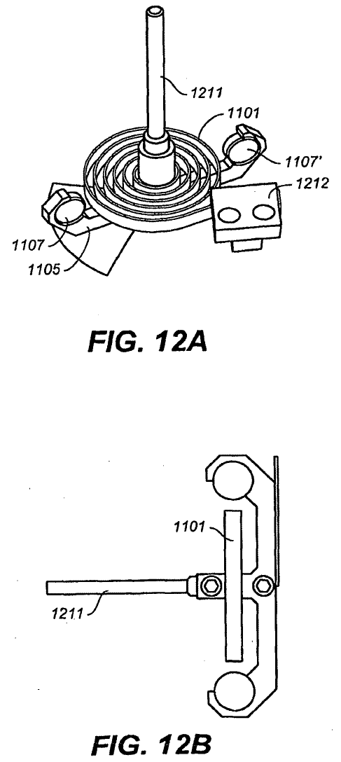

The clock spring 1101 shown in FIG. 11A has six nested coils. The center of the clock spring 1101 may be mounted to shaft, to which the mirror may be connected. In FIGS. 11A-11C, the center of the clock spring 1101 is mounted to a rotor 1105. The rotor may be part of the mirror driver, as described above. In the variation shown in FIGS. 11A-11C, the rotor 1105 includes two magnetic poles 1107, 1107′ which are fixed magnets that will interact with a magnetic field generated by a stator 1109. The stator 1109 may also be a component of the mirror driver, as described in more detail below. The rotor 1109 is fixed to the center of the clock spring 1101 and has a generally “T” shaped structure in which the arms of the “T” pass beneath the plane of the clock spring (defined by the coils). The fixed magnets 1107, 1107′ of the rotor are positioned at the ends of these arms, and are each centered in the same plane as the coils of the clock spring 1101. By positioning the magnets of the rotor in the same plane as the clock spring coils, out-of-plane bending or torque may be avoided. Although not shown in FIG. 11A-C, the rotor may project upwards through the plane of the coil and may provide a mounting surface for connection to the mirror(s). This is shown in more detail in FIGS. 12A and 12B. In some variations, the “T” shaped rotor has arms that fit both above and below the plane of the clock spring coils.

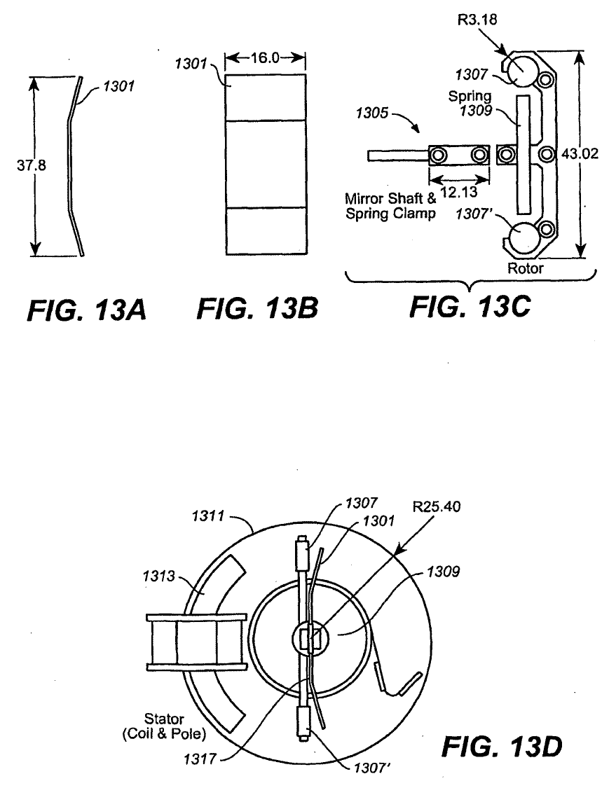

FIGS. 12A and 12B show a clock spring 1101 to which a rotor 1105 having two fixed magnets is attached. A post 1211 for mounting the mirror (not shown) may be attached to the center of the clock spring 1101 and/or the center of the rotor 1105. The mirror-mounting post may include a surface, clamp, screw, or the like for securing the mirror. In some variations, the mirror is directly connected to the center of the clock spring or to the rotor, and does not require an additional post. FIG. 12A also shows the housing mount 1212 for securing the clock spring (and therefore the entire mirror subassembly) to the housing. The subassembly housing mount 1212 shown is a bracket that secures the bias (clock spring) to the housing so that this end of the bias is effectively fixed with respect to the housing. FIGS. 13A-13D show schematic illustrations of many of the components of the resonant engine of FIGS. 10-12C.

FIGS. 13A and 13B show a side and front view, respectively, of a mirror 1301 that may be mounted to the resonant engine. This mirror is similar in design to the mirror shown in FIG. 10. Although FIGS. 13A and 13B indicates dimensions (in mm) for the mirror 1301, these dimensions are only exemplary. The mirror may be smaller (e.g., less than 10 mm long) or larger (greater than 50 mm long), and may be matched to the dimensions of the beam of light received by the light source or sources used. In some variations, the mirror 1301 is between about 1 mm and 500 mm wide and between about 1 mm and 500 mm tall.

FIG. 13C shows a side view of the mirror shaft (including a clamp) 1305 and the rotor 1317. The mirror shaft may therefore be clamped to the rotor 1317. As previously mentioned, the dimensions are only intended to illustrate one variation of the device. FIG. 13D shows a top view of the mirror subassembly (including mirror 1301, rotor 1317, clock spring 1309) that has been positioned within the housing 1311, so that the rotor 1317, including fixed magnets 1307, 1307′ are positioned adjacent to the stator 1313 that can produce a magnetic field that acts on the rotor to load and unload the bias 1309. In this variation, the stator and rotor are both components of the mirror driver.

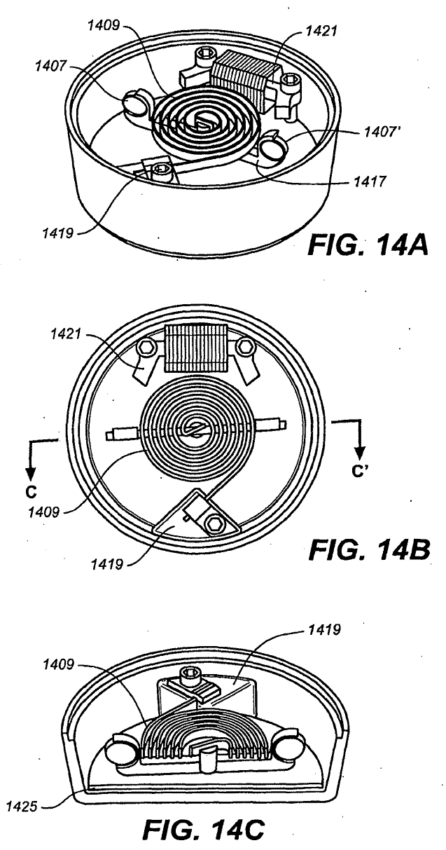

FIGS. 14A-14C show perspective, top and side cut-away views, respectively, of the portion of the resonant engine included within the housing 1411. For the sake of simplicity, the mirror portion of the resonant engine is not shown in these figures. The side perspective view shown in FIG. 14A shows the housing 1411, within which the mirror subassembly and at least a portion of the mirror driver are mounted. As described above, the mirror subassembly in this example includes a clock spring 1409 and rotor 1417 mounted in the center of the clock spring. The rotor includes two fixed magnets 1407, 1407′. The mirror subassembly is mounted in the housing only by the connection between the outer end of the clock spring 1409 and the housing mount 1419, so that the plane of the clock spring is parallel to the bottom of the housing. Thus, the mirror subassembly is suspended within the housing 1411, and is free to move in a substantially undamped fashion. This is apparent in FIG. 14C, which shows a cross-section through a perspective view of this example of a resonant engine taken through line C-C′ of FIG. 14B. The suspension of the mirror subassembly above the base of the housing is also apparent in FIG. 1 IC.

FIG. 14C also shows control circuit 1425 included as part of a printed circuit board (PCB) on the base of the housing. The control circuitry may include executable control logic for controlling the oscillation of the mirror subassembly. In particular, the control circuitry may be configured to control the motor driver so that force is applied to the mirror subassembly so that it moves at a resonant frequency. In FIGS. 14A-14C the motor driver includes the stator 1417 that is part of the mirror subassembly and the stator 1421. The stator 1421 includes a coil or winding and a pole. As previously mentioned, the stator generates an electromagnetic field that exerts force on the mirror subassembly. In some variations, this applied electromagnetic field exerts force by attracting and/or repelling the rotor 1417 (e.g., the magnets 1407, 1407′ attached to the rotor 1417)

Force applied by the stator loads (and/or unloads) the clock spring 1409 of the mirror subassembly. The loading and unloading of the clock spring results in the twisting (typically in the plane of the clock spring) of the mirror subassembly, and therefore the mirror. The force applied by to the mirror subassembly is typically related to the strength and orientation of the applied electromagnetic field emitted by the stator, and the stator may be controlled by the control circuitry 1425. The control circuitry may control the power supplied to the electromagnetic field. In particular, the control circuitry may regulate the stator so that the electromagnetic field applied drives the mirror subassembly in resonance.

Thus, the control circuitry may provide variable, pulsatile power to the mirror driver (e.g., stator) to both start the mirror subassembly oscillating, and thereafter to oscillate the mirror subassembly at or near a resonant frequency. In some variations, the control circuitry includes control logic that may maintain the steady-state resonant oscillation of the system. In some variations, the control circuitry may include one or more feedback loops that determine resonance of the mirror subassembly based on sensing either the motion of the mirror subassembly and/or the back electromagnetic force (EMF). Thus, one or more sensors (e.g., optical sensors, electrical sensors, motion sensors, etc.) may be used to provide information to the control circuitry. As used herein, “circuitry” may be any appropriate circuitry, including hardware, software, firmware, or some combination thereof, and is not limited to PCBs.

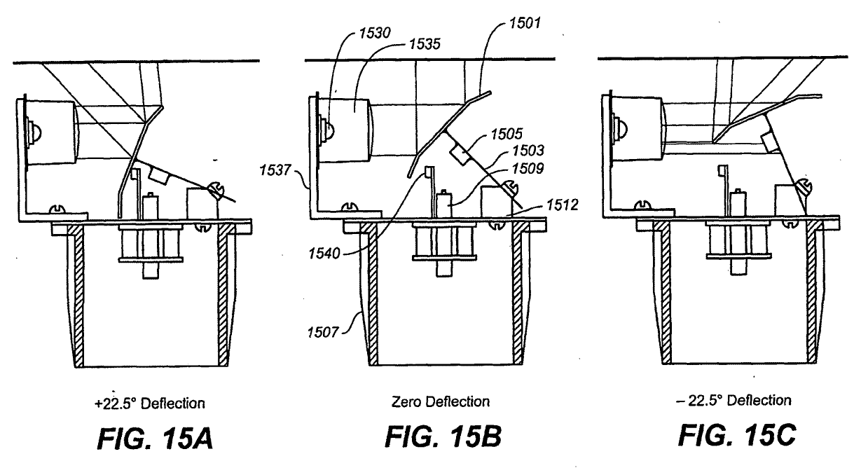

FIGS. 15A-15C illustrate another variation of a resonant engine in which the bias is a blade or bar, rather than a clock spring. Referring now to FIG. 15B, the resonant engine is shown in the neutral position, in which the mirror has a zero deflection (i.e., is centered in the range of oscillation). This variation of the resonant engine includes a mirror subassembly having a mirror 1501 connected to a bias 1503. The mirror subassembly is connected to the housing 1507 through mount 1512, by securing the bias near one end. The mirror 1501 is secured to the opposite end of the bias, and the bias and mirror are free to move (i.e., oscillate) in an undamped fashion. A light source 1530 is attached to the housing as well, and a collimator 1535 surrounds the light source so that emitted light is directed to towards the mirror 1501 of the mirror subassembly. The light source and collimator are mounted to the housing in a fixed position relative to the movable mirror subassembly, by means of a bracket 1537.

A fixed magnet (or magnetically permeable material) 1505 is attached to the bias 1503. The magnet 1505 forms a part of the mirror driver that also includes a voice coil 1509 which generates a magnetic field to attract or repel the fixed magnet, and can therefore cause deflection of the mirror subassembly and therefore the mirror. FIGS. 15A-15C also show a sensor 1540 that can provide information to the control circuitry (not shown). As previously mentioned, any appropriate sensor may be used, including (but not limited to) optical sensors, mechanical sensors, electromagnetic sensors, or the like.

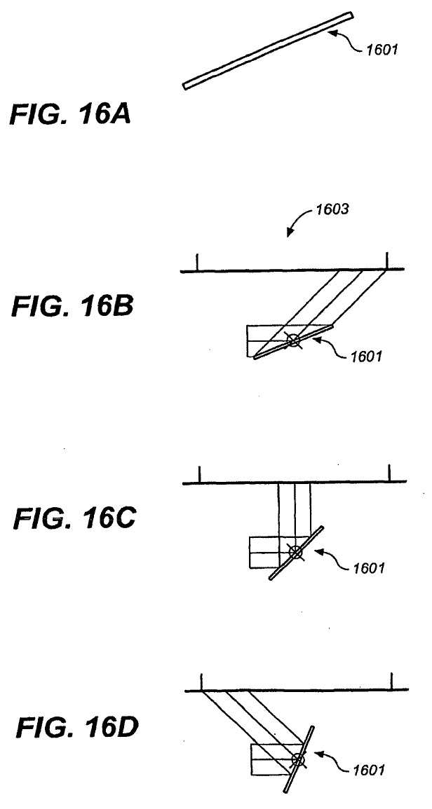

Referring to FIG. 15A, the mirror subassembly may be drawn towards the housing (positive deflection) by the application of energy to the voice coil, which applies electromagnetic force to attract the magnet 1505 and bend the bias 1503 downward. In this example the mirror subassembly is deflected downward by 22.5°, causing collimated light from the light source 1530 to be reflected off of two sides of the mirror 1501. Thereafter, the voice coil may either decrease, reverse, or turn off the emitted electromagnetic field, allowing the mirror subassembly to return towards the neutral position, as shown in FIG. 15B, or pass the neutral position and continue to move towards the position shown in FIG. 15C, which is deflected by −22.5° (negative deflection). As the mirror subassembly oscillates, the reflected light from the mirror is scanned over the target. In this variation, the mirror includes three flat regions. Thus, this mirror is one variation of a compound mirror, having three reflective regions. Each of the three reflective regions therefore produces a reflection of light that is scanned over the target to form the illumination pattern. Because of this, the effective scanning rate for light over the target is greater than twice the rate of oscillation. Thus, as previously mentioned, the scan rate and the quality of the illumination pattern may be improved by using more than one mirror, or by using a compound mirror as shown in FIGS. 15A-15C. This is further illustrated in FIGS. 16A-16D, 17A-17F, 18A-18F.

FIG. 16A shows a profile of a single-faced, flat mirror. FIGS. 16B-16D illustrate scanning of the single-faced mirror shown in FIG. 16A. In all of these figures, the light source (not shown) is positioned to the left of the mirror profile. In the neutral position shown in FIG. 16C, the flat mirror 1601 is shown positioned at a 45° angle from the light source. Since the angle of reflection is equal to the incident angle, light is reflected off of the mirror a 45° angle in FIG. 16C. FIG. 16B shows the reflection of light when the mirror is deflected upwards, moving the reflected light to form the right side of the illumination pattern 1603. Similarly, as the mirror is deflected in the opposite direction, the reflected light is scanned to the left. As the mirror is oscillated, the entire illumination pattern 1603 is illuminated by this scanning. In this example, the single, flat mirror scans the reflected light at twice the rate that the mirror is oscillated (e.g., a single spot of light travels across the illumination pattern twice for every cycle of mirror movement (e.g., backwards and forwards).

FIG. 17A shows a mirror having a compound profile, in which the mirror comprises three flat regions positioned at an angle with respect to each other. As previously described for FIGS. 15A-15C (which illustrated a similar compound mirror), each face of the mirror may reflect the light at a slightly different angle, resulting in multiple scanning reflections forming the illumination pattern. In this example, the mirror may be angled so that some of the light from the light source is lost (e.g., not reflected by the moving mirror), as shown in FIGS. 17B and 17C. In FIGS. 17B-17F, as the mirror is deflected upwards from the neutral position of FIG. 17D, the mirrored regions on either side of the mirror reflect light to the edges of the illumination pattern. However, when the mirror is deflected downwards from the neutral pattern, only the central region of the mirror illuminates the illumination pattern. Thus, the illumination pattern is formed by a variable scanning rate depending on the deflection of the mirror during the oscillation. In practice, the effect of scanning the edges of the illumination pattern during positive deflection may result in a more uniform or brighter perceived illumination pattern.

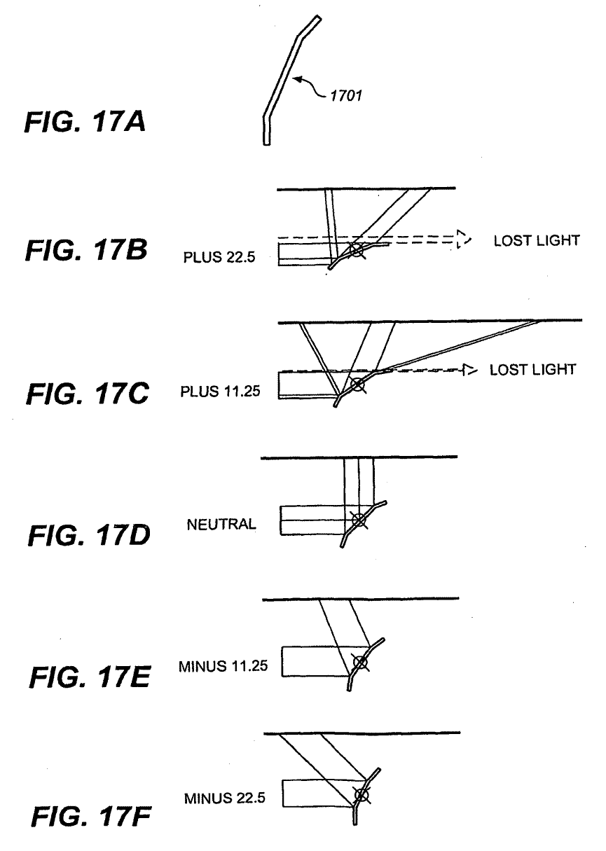

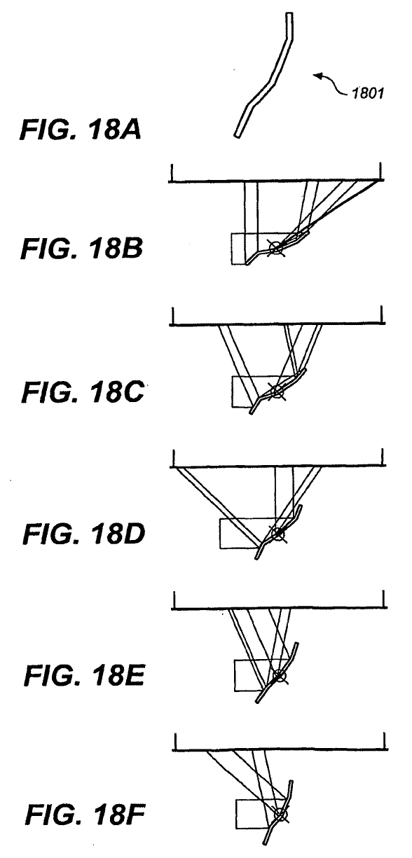

FIG. 18A shows another variation of a compound mirror profile for a mirror having four fat regions. FIGS. 18B-18F illustrate the formation of the illumination pattern as the mirror is oscillated. FIG. 18D shows the neutral position, while FIGS. 18B and 18F show the extreme upwards and downwards displacement, respectively.

As previously mentioned, any appropriate mirror may be used, including curved mirrors, or mirrors that include both concave and/or convex regions, multifaceted regions and flat regions. In some variations, the mirrors are non-flat shapes, and may have three-dimensional cross-sections such as polygonal (e.g., triangular, rectangular, pentagonal, hexagonal, heptagonal, octagonal, etc.) cross-section.

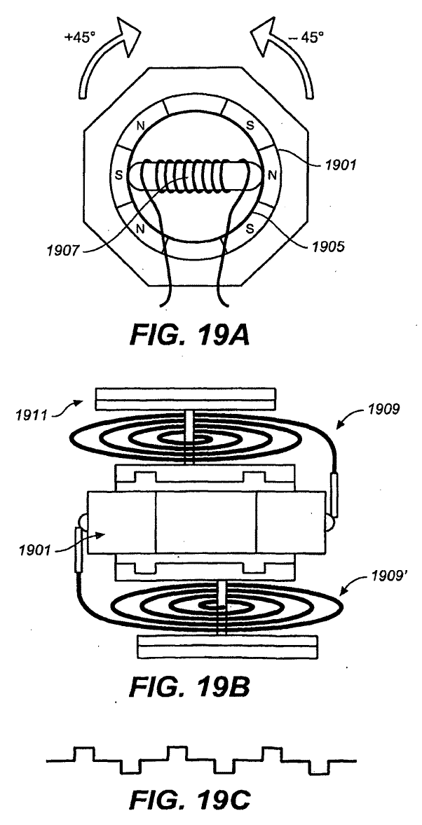

FIGS. 19A-19B show one variation of a resonant engine configured as a galvanometer-type device, in which the mirror subassembly includes a mirror having a hexagonal cross-section. In this variation, the resonant engine includes the mirrored outer shell 1901. A mirror drive consists of both a multi-pole magnet 1905 distributed as an annular ring within this reflective core, and a stator 1907 having a coil and a pole. FIG. 19B shows two clock springs 1909, 1909′, each attached to the center of the oscillating mirror (including the multi-pole magnet). The outer end of each clock spring is attached to a housing 1911, and may be decoupled by rubber to minimize additional vibration. Current through the stator 1907 induces an electromagnetic field, causing the mirrored shell to rotate and load/unload the biases. Thus, the mirror may be oscillated.

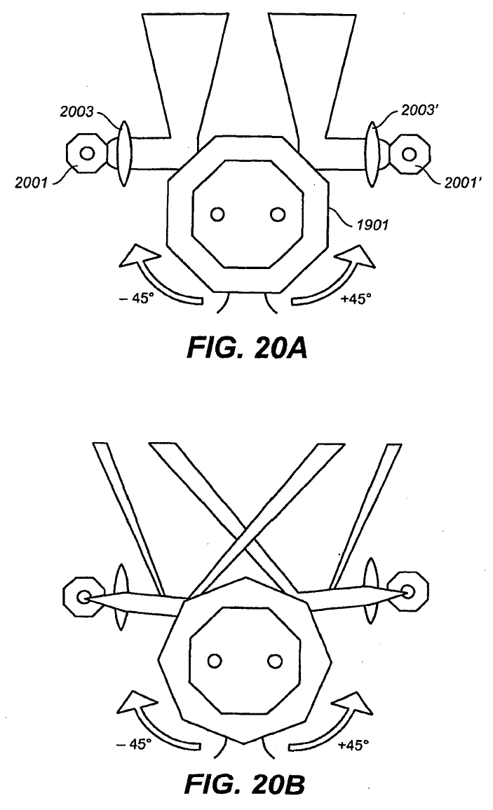

FIG. 19C shows one variation of a drive signal (e.g., current or voltage profile) supplied to the motor to create the magnetic field and move the mirror subassembly (e.g., bias and mirror) in the embodiment of FIGS. 19A and 19B. By changing the polarity of the drive signal the direction of the force applied is changed. FIGS. 20A and 20B illustrate the operation of a resonant engine similar to that described in FIGS. 19A-19B.

In FIGS. 20A-20B, two light sources 2001, 2001′ are used with the resonant engine. Each light source is collimated by a collimating lens 2003, 2003′, and the mirror subassembly is oscillated (e.g., at ±45°) at a resonant frequency by the application of current through the stator. In any of the variations described herein either a single illumination pattern (overlapping the multiple reflections of light) may be formed, or a multiple illumination patterns may be formed. Thus, an illumination pattern may be formed by overlapping the scan patterns of different mirrors.

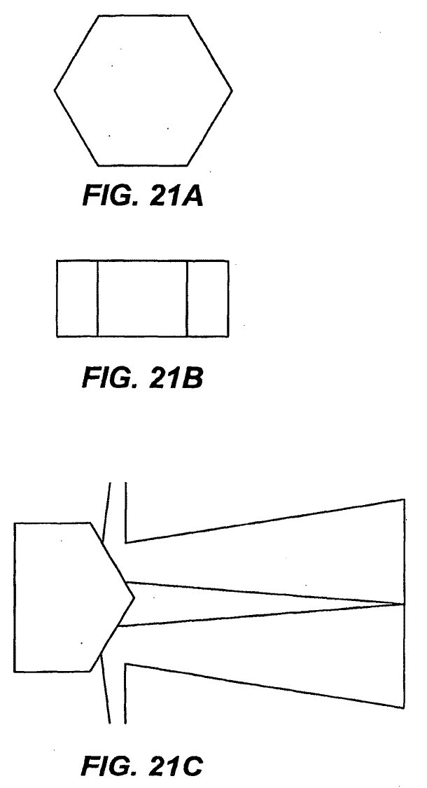

FIGS. 21A-21C, 22A-22C, 23A-23B, and 24A-24C show different mirrors or reflectors that may be used, particularly with the galvanometer-type design described above. For example, FIG. 21A shows a mirror having a hexagonal cross-sectional profile. A side perspective view of this same mirror is shown in FIG. 21B, and FIG. 21C illustrates an example of the reflection pattern of such a mirror, when it is used with two light sources.

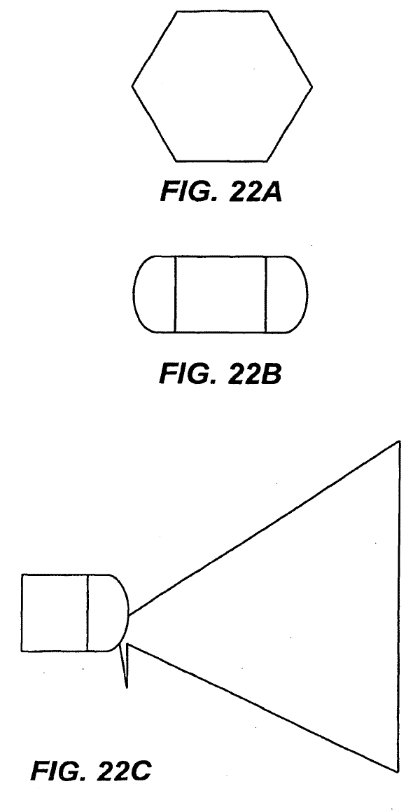

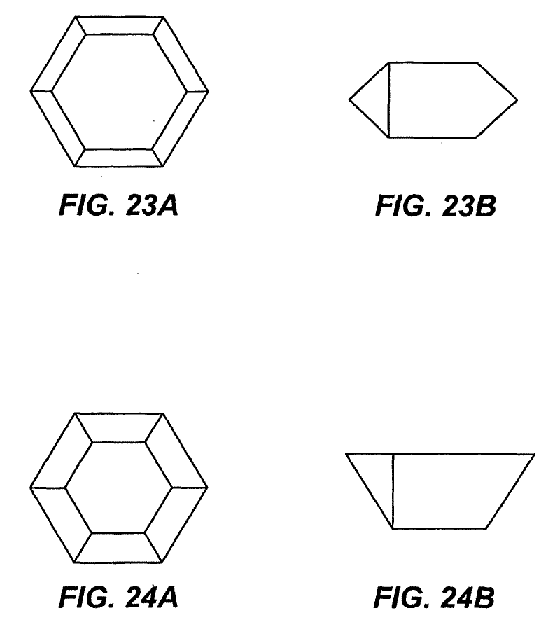

FIG. 22A-22C shows a similar mirror, in which the reflector has a curved profile, as shown in FIG. 22B, which may result in spreading the reflected light, as shown in FIG. 22C. Mirrors may also have angled reflective surfaces that may create a wider spread for the illumination pattern, as shown in FIGS. 23A and 23B, showing both a top view and a side view, respectively. FIGS. 24A and 24B illustrate another variation of the mirror similar to that shown in FIGS. 23A and 23B.

Additional examples of resonant engine described herein also include devices that are within, part of, or adapted for use with an incandescent light bulb. Thus, the resonant engine may be within the bulb itself (e.g., within the vacuum chamber of the bulb) so that light from the filament is reflected by the mirror. In any of the variations described herein, the resonant engine may be adjustable so that the pattern of light formed by the resonant engine and light source is adjustable by a user. For example in the incandescent bulb variation described above, a bulb including a resonant engine may be screwed (or otherwise inserted) into a light socket such as an overhead light socket, and controlled by a switch on the wall, which may adjust the illumination area, and otherwise power the device.

In some variations of the devices described herein, the mirror subassembly includes a light source. For example, an LED or other optic for illumination may be mounted to (or part of) the bias, so that vibration of the mirror subassembly at a resonant frequency moves the light source as well as the reflector. In some variations, the mirror is not a planar or flat mirror, but is a reflector that condenses or directs light from the light source on the mirror subassembly. Thus, the mirror may comprise a lens as well as, or in addition to, the reflective surface.

The above detailed description is provided to illustrate exemplary embodiments and is not intended to be limiting. For example, any of the features of an embodiment may be combined with some or all of the features of other embodiments. Furthermore, although the majority of examples described herein are specific to visible light, it should be clear that the devices, systems and methods described herein apply to non-visible regions of the electromagnetic spectrum. For example, the illumination source described herein may be a UV, IR, or other illumination source, and the mirror may be a reflector compatible with such an illumination source. Exemplary uses of the resonant engine for non-visible light include laser levels, ultrasound measurements, night vision for cameras, and leak detection.

It will be apparent to those skilled in the art that numerous modifications and variations within the scope of the present invention are possible. Throughout this description, particular examples have been discussed, including descriptions of how these examples may address certain disadvantages in related art. However, this discussion is not meant to restrict the various examples to methods and/or systems that actually address or solve the disadvantages. Accordingly, the present invention is defined by the appended claims and should not be limited by the description herein.

What is claimed is:

1. A device configured to direct light to illuminate a target area, the device comprising:
a movable mirror, wherein the mirror is operatively connected to a bias; wherein the bias is mounted to an engine support; further wherein the bias is configured to move the mirror with respect to the engine support in an undamped oscillation; and
a mirror driver configured to move the mirror at a resonant frequency by loading and unloading the bias,
wherein the mirror is further configured to project collimated light produced by a light source to form an illumination pattern when the light source is activated and the mirror is moving at the resonant frequency or a harmonic.

2. The device of claim 1, wherein the bias is selected from the group consisting of: a spring, an electrometric band, a string, a plastic member, a rubber member, a metal member, and a composite member.

3. The device of claim 1, wherein the engine support comprises a housing.

4. The device of claim 1, wherein the bias is a clock spring.

5. The device of claim 1, wherein the bias is selected from the group consisting of a torsion spring, a coil spring, a spiral spring, a spiral-torsion spring, and a helical spring.

6. The device of claim 1, wherein the mirror driver comprises a magnet and an electromagnetic coil.

7. The device of claim 1, wherein the mirror driver comprises an electromagnet.

8. The device of claim 1, wherein the mirror driver is selected from the group consisting of: a motor, a voice coil motor, a reciprocal electromagnetic driver, a piezoelectric driver, a solenoid, a liner solenoid, a magnetostrictive driver, a MEMS driver.

9. The device of claim 1 further comprising a lens for modifying the light reflected by the mirror.

10. The device of claim 1 further comprising a second mirror for modifying the light reflected by the mirror, when the shape of the second mirror is selected from the group consisting of spherical, elliptical, parabolic, and off-axis.

11. The device of claim 1, wherein the mirror driver comprises a rotor having at least one of a magnet, electromagnet or coil, that is configured to be acted upon by an electromagnet.

12. The device of claim 1, wherein the resonant frequency is between about 10 and about 1000 Hz.

13. The device of claim 1, wherein the resonant frequency is between about 40 and about 180 Hz.

14. A method for efficiently illuminating a wide pattern of illumination, the method comprising:
moving a mirror of a mirror system at a resonant frequency for the mirror system, wherein the resonant frequency is between about 10 and about 1000 Hz, and wherein the mirror system comprises:
a bias, operatively connected to said mirror;
a housing, wherein the bias is operatively connected to the housing; and
a mirror driver, configured to load the bias and thereby drive movement of the mirror; and
illuminating a light source to produce collimated light, wherein light from the light source is reflected from the mirror to produce a target pattern of illumination.

15. A device for reflecting light over a broad region, the device comprising:
a mirror configured to receive and reflect light from a light source, wherein the mirror is operatively connected to a rotor;
a bias mounted to an engine support, wherein the bias is operatively connected to the rotor so that the mirror oscillates when the bias is loaded and unloaded by moving the rotor; and
a stator connected to the engine support, wherein the stator is configured to act on the rotor and load the bias.

16. The device of claim 15, wherein the shape of the mirror is selected from the group consisting of: bent, straight, curved, facetted, sectioned, or some combination thereof.

17. The device of claim 15, wherein the bias comprises a clock spring.

18. The device of claim 15, wherein the bias is selected from a group consisting of: a spring, an electrometric band, a string, a plastic or rubber moveable member, and a composite member.

19. The device of claim 15, further comprising a power source connected to said stator, wherein the power source is selected from the group consisting of: a fuel cell, a battery, a solar power source, an AC power source, a DC power source, an AC to DC converter, a DC to non DC converter.

20. The device of claim 15, further comprising a light source configured to provide collimated light.

21. The device of claim 15, further comprising light that has been focused or concentrated.

22. The device of claim 15, wherein the engine support is configured as a housing.

23. The device of claim 22, further comprising a cover for the housing, wherein at least a portion of the mirror is outside of the region enclosed by the cover and housing.

24. The device of claim 15, wherein the rotor comprises at least one magnet.

25. The device of claim 15, further comprising control circuitry for controlling the energy applied to the stator to act on the rotor.
